(19) United States
(12) Patent Application Publication
(10) Pub. No.: US 2014/0193999 A1
(43) Pub. Date: Jul. 10, 2014

(54) CONNECTOR AND INTEGRALLY MOLDED PRODUCT

(71) Applicant: Yazaki Corporation, Tokyo (JP)

(72) Inventors: Takeo KOGA, Makinohara-shi (JP); Isanori SHIMIZU, Makinohara-shi (JP)

(73) Assignee: YAZAKI CORPORATION, Tokyo (JP)

(21) Appl. No.: 14/202,655

(22) Filed: Mar. 10, 2014

Related U.S. Application Data
(63) Continuation of application No. PCT/JP2012/074997, filed on Sep. 21, 2012.

(30) Foreign Application Priority Data
Sep. 22, 2011 (JP) 2011-207222

(51) Int. Cl. H01R 13/46

(52) U.S. Cl. CPC H01R 13/46
USPC 439/527

(57) ABSTRACT

A connector made of fiber reinforced resin includes a case and a connector port integrally molded with the case on one surface of the connector. A force by which the connector is warped to a side to the connector port is produced by disorder of orientation of fibers caused by the case and the connector port. A surface opposite to the one surface located between the case and the connector port is provided with a warping prevention part which includes at least one of a concave part and a convex part and extends along the case and the connector port. A force by which the connector is warped to a side opposite to the connector port is produced by disorder of orientation of fibers in the warping prevention part.

### CROSS REFERENCE TO RELATED APPLICATIONS

This application is a continuation of PCT application No. PCT/2012/074997, which was filed on Sep. 21, 2012 based on Japanese Patent Application (No. 2011-207222) filed on Sep. 22, 2011, the contents of which are incorporated herein by reference.

### BACKGROUND OF THE INVENTION

1. Field of the Invention

The present invention relates to an integrally molded product made of fiber reinforced resin in which a case and a connector port are integrally molded on one surface.

2. Description of the Related Art

In connectors of the following JP-A-2010-003550 and JP-A-2010-017069, one surface is equipped with a case and a connector port. This kind of connector includes a connector in which the case and the connector port are integrally molded of fiber reinforced resin of the same material.

In this connector, a rib with the same shape as that of the connector port is formed in a position opposed to the connector port on a surface opposite to a formation surface of the case and the connector port in order to prevent the connector port side from warping to the case side with cooling of the resin at the time of molding.

### SUMMARY OF THE INVENTION

The conventional connector described above has problems that layout of elements is limited by forming the rib and also an increase in the amount of resin by the rib results in increasing the weight.

The invention has been implemented in view of such problems, and an object of the invention is to provide a connector and an integrally molded product capable of solving the problems described above.

According to an aspect of the present invention, a connector made of fiber reinforced resin includes a case and a connector port integrally molded with the case on one surface of the connector. A force by which the connector is warped to a side to the connector port is produced by disorder of orientation of fibers caused by the case and the connector port. A surface opposite to the one surface located between the case and the connector port is provided with a warping prevention part which includes at least one of a concave part and a convex part and extends along the case and the connector port. A force by which the connector is warped to a side opposite to the connector port is produced by disorder of orientation of fibers in the warping prevention part.

According to another aspect of the present invention, an integrally molded product includes a case, a joint, and a connector tubular part. The case, the joint and the connector tubular part are integrally molded on one side of a base of the product in this order. A force by which the connector is warped to a side to the connector port is produced by disorder of orientation of fibers caused by the case and the connector port. In the joint between the case and the connector tubular part, a side opposite to the one side is provided with a warping prevention part including at least one of a concave part and a convex part. A force by which the base is warped to the side opposite to the one side is produced by disorder of orientation of reinforcement fibers included in the molded product in the warping prevention part.

According to the invention, the force by which the connector is warped is offset by the warping prevention part, so that warping of the connector can be prevented without forming a rib having the same shape as that of the connector port.

### BRIEF DESCRIPTION OF THE DRAWINGS

FIGS. 1A to 1C are views showing a connector of one embodiment of the invention, and FIG. 1A is a front view of the connector, FIG. 1B is a cross-sectional view taken along the line A-A in FIG. 1A, and FIG. 1C is a rear view of the connector.

FIG. 2 is an enlarged sectional view of the inside of a frame B of FIG. 1B.

FIGS. 3A and 3B are views showing comparison between the connector of FIGS. 1A to 1C and a conventional connector, and FIG. 3A is a view showing a conventional connector, and FIG. 3B is a view showing the connector of one embodiment of the invention.

FIGS. 4A to 4C are views showing a modified example of the connector, and FIG. 4A is a front view of the modified example of the connector, FIG. 4B is a cross-sectional view taken along the line A-A in FIG. 4A, and FIG. 4C is a rear view of the modified example of the connector.

FIG. 5 is an enlarged sectional view of the inside of a frame C of FIG. 4B.

### DETAILED DESCRIPTION OF THE EXEMPLARY EMBODIMENTS

One embodiment of the invention will hereinafter be described with reference to the drawings.

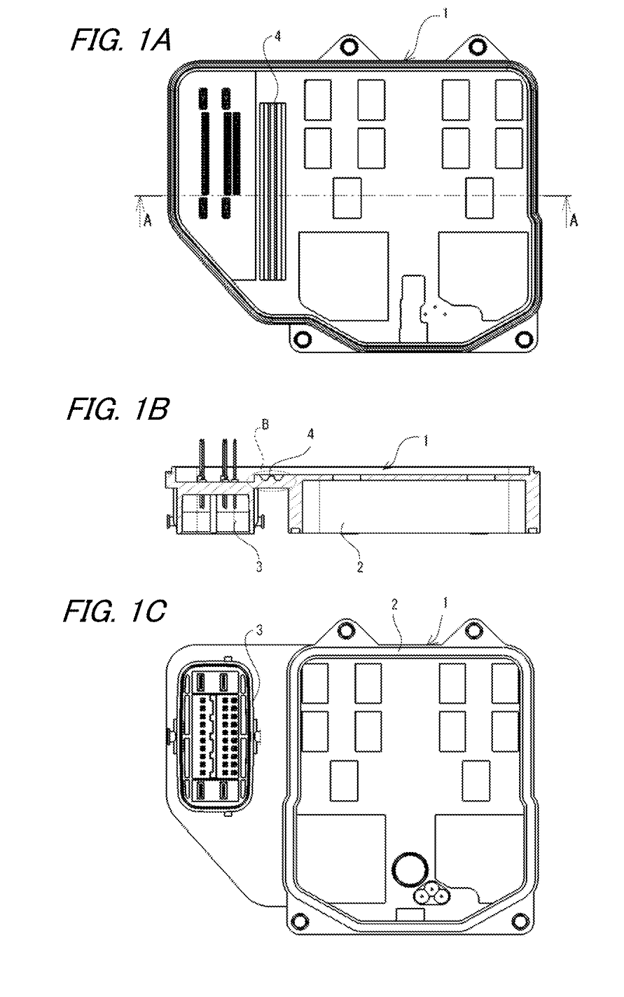

In a connector 1 shown in FIGS. 1A to 1C, a case 2 and a connector port 3 are formed integrally to the back of a base. The connector 1 is made of fiber reinforced resin reinforced by glass fiber etc., and the case 2 and the connector port 3 are also integrally molded of the fiber reinforced resin of the same material.

The front of the connector 1 is formed with an uneven part 4 including concave parts and convex parts with substantially trapezoidal cross sections. The uneven part 4 is formed in a joint between the case 2 and the connector port 3 of the base, and linearly extends along the case 2 and the connector port 3.

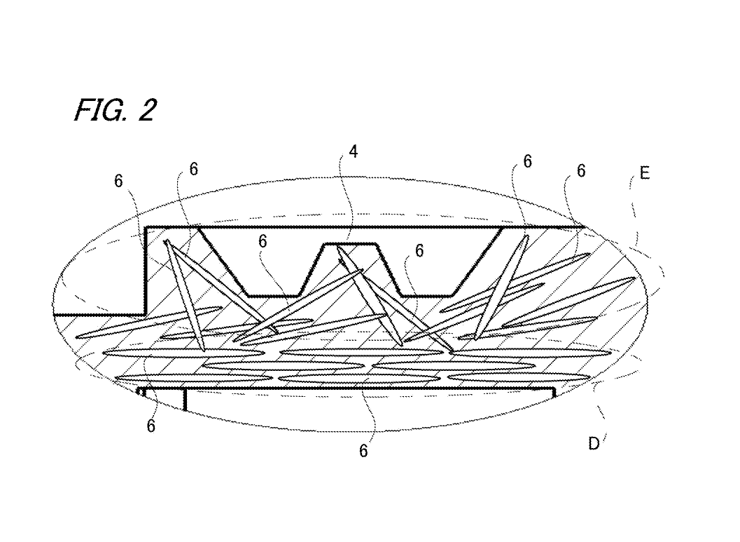

In a flat part of the back side of the connector 1, fibers 6 in the resin forming the connector 1 are arranged along the front of the connector 1 as enlarged and shown inside a frame D of FIG. 2. In formation positions of the case 2 and the connector port 3, the fibers 6 are also arranged along the side surfaces of these positions (not shown), so that disorder is caused in orientation of the fibers 6. As a result, in the back side of the connector 1, a force by which the connector 1 is warped to the back side acts on the portion located between the case 2 and the connector port 3.

On the other hand, in a flat part of the front side of the connector 1, the fibers 6 in the resin forming the connector 1 are arranged along the front of the connector 1 as enlarged and shown inside a frame E of FIG. 2, and the fibers 6 are also arranged along the side surfaces of the concave parts and the convex parts in the uneven part 4, so that disorder is caused in orientation of the fibers 6. As a result, in the front side of the connector 1, a force by which the connector 1 is warped to the front side acts on the portion located between the case 2 and the connector port 3.

As a result, in the portion located between the case 2 and the connector port 3, the force by which the connector 1 is warped to the back side is offset by the force by which the connector 1 is warped to the front side, and flatness of the connector 1 is maintained.

According to the embodiment, the force by which the connector 1 is warped to the front side acts using the uneven part 4 formed in the front of the connector 1 as the boundary and thereby, the force by which the connector 1 is warped to the back side is offset at the boundary between the case 2 and the connector port 3, so that warping of the connector 1 can be prevented without providing the front of the connector 1 with a rib having the same shape as that of the connector port 3.

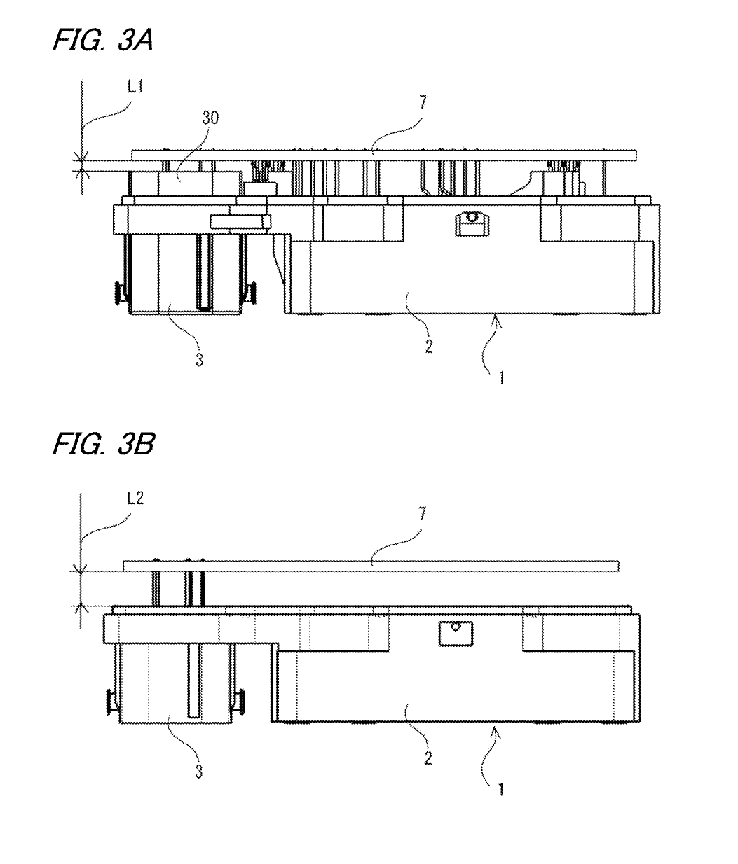

As a result, while a conventional connector 1 (see FIG. 3A) including a rib having the same shape as that of a connector port 3 on the back has a distance L1 between the connector 1 and a substrate 7 in a formation position of the connector port 3, in the connector 1 of the embodiment, a distance L2 (see FIG. 3B) between the connector 1 and the substrate 7 in the formation position of the connector port 3 can be increased by the length in which the rib 30 is not included. Therefore, elements can also be arranged on the back side of the connector port 3, and flexibility of layout of the elements mounted in the substrate 7 improves.

Also, the product weight of the connector 1 can be reduced by the amount in which the rib 30 having the same shape as that of the connector port 3 is not formed. Also, plane accuracy of a vibration weld surface of a component or alignment accuracy of a bus bar and a terminal used in connection between the connector 1 and the substrate 7 can be increased by preventing the warping of the connector 1.

In addition, in the embodiment described above, the uneven part 4 constructing a warping prevention part is configured to include one convex part between two concave parts, but the number of concave parts and the number of convex parts are arbitrary. Also, the warping prevention part may be constructed of only one of the concave parts and the convex parts. Also, a cross-sectional shape of the concave parts and the convex parts constructing the uneven part 4 does not have to be the cross-sectional trapezoidal shape, and may be formed in a cross-sectional rectangular shape.

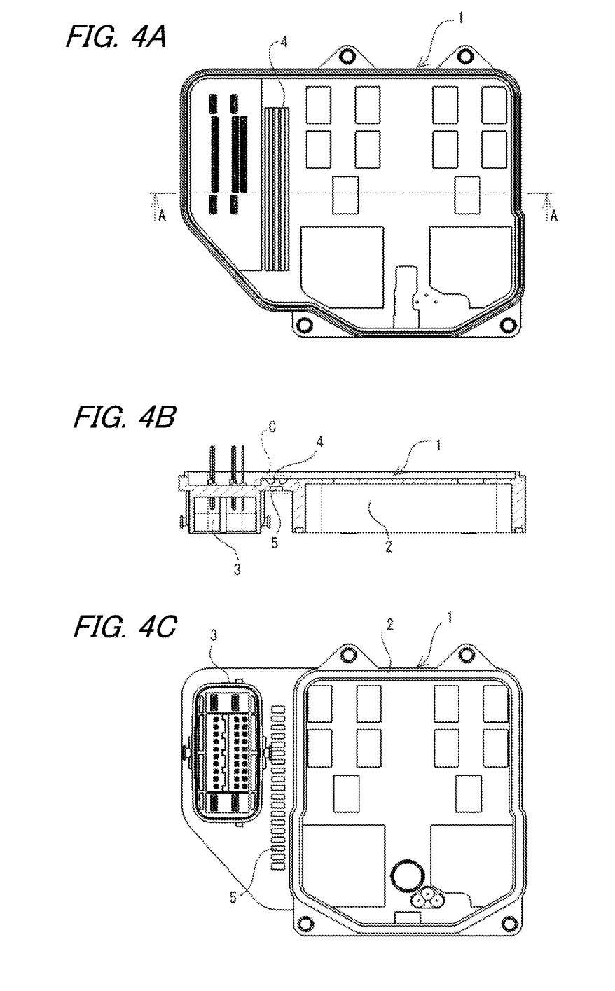

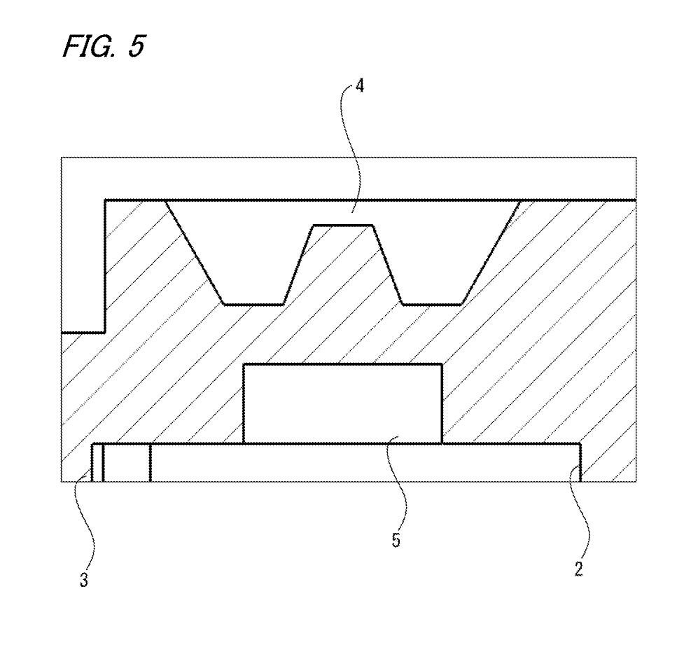

Also, not only the front of the connector 1 is provided with the uneven part 4 but also the back of the connector 1 may be formed with a rib 5 as shown in FIGS. 4B and 4C. The rib 5 has a concave shape with a rectangular cross section as enlarged and shown in FIG. 5. The rib 5 is formed in a position opposed to the uneven part 4 between the case 2 and the connector port 3, and linearly extends along the case 2 and the connector port 3.

According to this configuration, in the portion located between the case 2 and the connector port 3, the connector 1 becomes resistant to being warped to the back side at the boundary between the case 2 and the connector port 3, so that warping of the connector 1 can be prevented effectively. Also, a material of the connector 1 is any fiber reinforced resin. Also, the invention can be applied to other integrally molded products in which a connector tubular part corresponding to the connector port 3, a joint and the case 2 are integrally molded on one surface of a base in order of the connector tubular part, the joint and the case 2.

The present invention is useful for providing a connector and an integrally molded product that can suppress warping without a layout of elements being limited and also without a weight being increased.

What is claimed is:

1. A connector made of fiber reinforced resin comprising:
a case; and
a connector port integrally molded with the case on one surface of the connector,
wherein a force by which the connector is warped to a side to the connector port is produced by disorder of orientation of fibers caused by the case and the connector port,
a surface opposite to the one surface located between the case and the connector port is provided with a warping prevention part which includes at least one of a concave part and a convex part and extends along the case and the connector port, and
a force by which the connector is warped to a side opposite to the connector port is produced by disorder of orientation of fibers in the warping prevention part.

2. An integrally molded product comprising:
a case;
a joint; and
a connector tubular part,
wherein the case, the joint and the connector tubular part are integrally molded on one side of a base of the molded product in this order,
a force by which the connector is warped to a side to the connector port is produced by disorder of orientation of fibers caused by the case and the connector port,
in the joint between the case and the connector tubular part, a side opposite to the one side is provided with a warping prevention part including at least one of a concave part and a convex part, and
a force by which the base is warped to the side opposite to the one side is produced by disorder of orientation of reinforcement fibers included in the molded product in the warping prevention part.
